(19) United States
(12) Patent Application Publication
(10) Pub. No.: US 2021/0279473 A1
(43) Pub. Date: Sep. 9, 2021

(54) VIDEO PROCESSING METHOD AND APPARATUS, ELECTRONIC DEVICE, AND STORAGE MEDIUM

(71) Applicant: SHANGHAI SENSETIME INTELLIGENT TECHNOLOGY CO., LTD., Shanghai (CN)

(72) Inventor: Jiafei WU, Shanghai (CN)

(73) Assignee: SHANGHAI SENSETIME INTELLIGENT TECHNOLOGY CO., LTD., Shanghai (CN)

(21) Appl. No.: 17/330,228

(22) Filed: May 25, 2021

Related U.S. Application Data
(63) Continuation of application No. PCT/CN2020/080683, filed on Mar. 23, 2020.

(30) Foreign Application Priority Data
May 15, 2019 (CN) 201910407853.X

(51) Int. Cl. G06K 9/00; G06T 7/00; G06K 9/62

(52) U.S. Cl. CPC G06K 9/00744; G06K 9/00765; G06T 2207/30168; G06K 9/629; G06T 2207/10016; G06T 7/0002

(57) ABSTRACT

Provided are a video processing method and apparatus, an electronic device, and a storage medium. The video processing method includes: acquiring at least one candidate video frame sequence; performing intra-sequence frame selection on each candidate video frame sequence to obtain a first frame selection result respectively corresponding to each candidate video frame sequence; and performing global frame selection based on all the first frame selection results to obtain a final frame selection result.

### CROSS-REFERENCE TO RELATED APPLICATION

The present application is a continuation of International Patent Application No. PCT/CN2020/080683 filed on Mar. 23, 2020, that is based upon and claims priority to Chinese patent application No. 201910407853.X filed on May 15, 2019, the disclosures of which are all hereby incorporated by reference in their entirety.

### BACKGROUND

In video analysis, objects usually may produce hundreds of images in a picture. In the case of limited computing resources, the objects are not necessarily all used for subsequent operations. In order to utilize information of captured images better, several images may be selected from the entire video for operation, and such a process is called frame selection.

### SUMMARY

The present disclosure relates to the technical field of image processing, and more particularly, to a video processing method and apparatus, an electronic device, and a non-volatile storage medium.

A first aspect of the present disclosure provides a method for video processing, which may include that: at least one candidate video frame sequence is acquired; intra-sequence frame selection is performed on each candidate video frame sequence to obtain a first frame selection result respectively corresponding to each candidate video frame sequence; and global frame selection is performed based on all the first frame selection results to obtain a final frame selection result.

A second aspect of the present disclosure provides an apparatus for video processing, which may include: an acquisition module, configured to acquire at least one candidate video frame sequence; an intra-sequence frame selection module, configured to perform intra-sequence frame selection on each candidate video frame sequence to obtain a first frame selection result respectively corresponding to each candidate video frame sequence; and a global frame selection module, configured to perform global frame selection based on all the first frame selection results to obtain a final frame selection result.

A third aspect of the present disclosure provides an electronic device, which may include: a processor; and a memory configured to store instructions executable by the processor, the processor calling the executable instructions to implement the method for video processing according to the embodiments of the present disclosure.

A fourth aspect of the present disclosure provides a non-volatile computer-readable storage medium, which may store a computer program instruction thereon. The computer program instruction may be executed by a processor to implement the method for video processing according to the embodiments of the present disclosure.

According to the following detailed descriptions on the exemplary embodiments with reference to the accompanying drawings, other features and aspects of the embodiments of the present disclosure become apparent.

### BRIEF DESCRIPTION OF THE DRAWINGS

The accompanying drawings, which are incorporated in and constitute a part of this specification, illustrate embodiments consistent with the present disclosure and, together with the description, serve to explain the technical solutions of the embodiments of the present disclosure.

FIG. 1 is a schematic flowchart 1 of a video processing method according to an embodiment of the present disclosure.

FIG. 2 is a schematic diagram of segmenting a video frame sequence according to an embodiment of the present disclosure.

FIG. 3 is a schematic flowchart 2 of a video processing method according to an embodiment of the present disclosure.

FIG. 4 is a schematic diagram of a frame selection process according to an embodiment of the present disclosure.

FIG. 5 is a schematic flowchart 3 of a video processing method according to an embodiment of the present disclosure.

FIG. 6 is a schematic diagram of an application example according to an embodiment of the present disclosure.

FIG. 7 is a block diagram of a video processing apparatus according to an embodiment of the present disclosure.

FIG. 8 is a block diagram of an electronic device according to an embodiment of the present disclosure.

FIG. 9 is another block diagram of an electronic device according to an embodiment of the present disclosure.

### DETAILED DESCRIPTION

Various exemplary embodiments, features and aspects of the present disclosure will be described below in detail with reference to the accompanying drawings. A same numeral in the accompanying drawings indicates a same or similar component. Although various aspects of the embodiments are illustrated in the accompanying drawings, the accompanying drawings are unnecessarily drawn according to a proportion unless otherwise specified.

As used herein, the word “exemplary” means “serving as an example, embodiment, or illustration”. Thus, any embodiment described herein as “exemplary” is not necessarily to be construed as preferred or advantageous over other embodiments.

The term “and/or” in this disclosure is only an association relationship for describing associated objects and represents that three relationships may exist. For example, A and/or B may represent the following three cases: only A exists, both A and B exist, and only B exists. In addition, the term “at least one type” herein represents any one of multiple types or any combination of at least two types in the multiple types, for example, at least one type of A, B and C may represent any one or multiple elements selected from a set formed by the A, the B and the C.

In addition, for describing the embodiments of the present disclosure better, many specific details are presented in the following specific implementations. It is to be understood by those skilled in the art that the embodiments of the present disclosure may still be implemented even without some specific details. In some examples, methods, means, components and circuits known very well to those skilled in the art are not described in detail, to highlight the subject of the embodiments of the present disclosure.

It is to be understood that the method embodiments mentioned in the present disclosure may be combined with each other to form a combined embodiment without departing from the principle and logic, which is not elaborated in the embodiments of the present disclosure for the sake of simplicity.

In addition, the embodiments of the present disclosure also provide an image processing apparatus, an electronic device, a computer-readable storage medium and a program, which may be used for implementing any image processing method provided by the embodiments of the present disclosure. The corresponding technical solution and description will not be described in detail, please refer to the corresponding description in the method part.

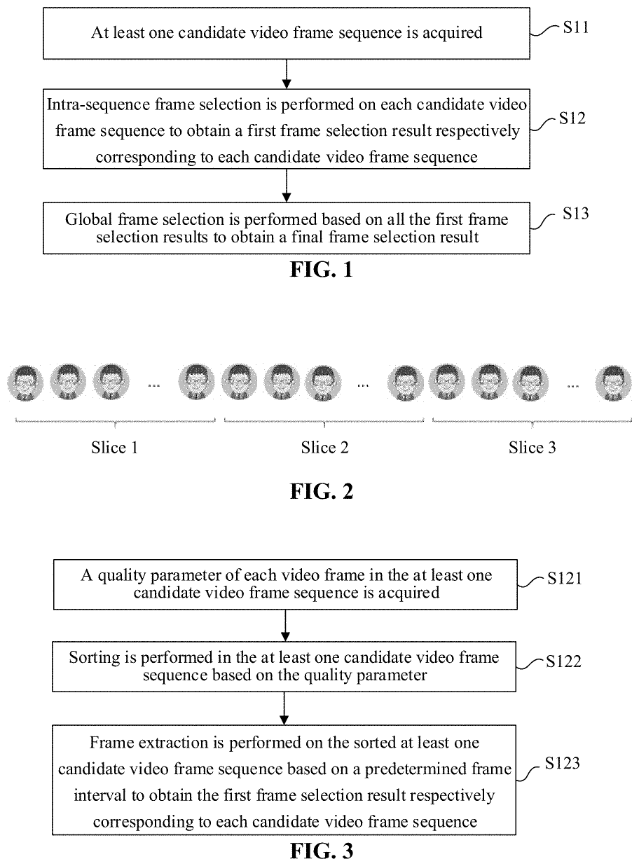

FIG. 1 is a schematic flowchart 1 of a video processing method according to an embodiment of the present disclosure. The video processing method may be executed by a terminal device or other processing devices, etc. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device, etc. In some possible implementations, the video processing method may be implemented by enabling a processor to call a computer-readable instruction stored in a memory.

As shown in FIG. 1, the video processing method includes the following operations.

In operation S11, at least one candidate video frame sequence is acquired.

In one or more examples, a quantity of video frames included in each candidate video frame sequence is not limited, which may be determined based on parameters such as frame rate and length of each candidate video frame sequence.

In the embodiments, no limit is set for a manner of acquiring a candidate video frame sequence. In one or more examples, before the operation S11, the method may include that: a video frame sequence is acquired; and the video frame sequence is taken as a candidate video frame sequence.

In the embodiments, the acquired video frame sequence as a whole may be directly taken as a candidate video frame sequence, and a frame selection operation may be directly carried out on the candidate video frame sequence. In this case, a first frame selection result obtained by subjecting the candidate video frame sequence to the subsequent frame selection operation may be directly taken as a global frame selection result and applied to any corresponding scenario. In an example, the method may be used in scenarios such as feature extraction, attribute extraction or information fusion.

In one or more examples, before the operation S11, the method may also include that: a video frame sequence is acquired; and the video frame sequence is segmented to obtain a plurality of sub-video frame sequences, and the sub-video frame sequence is taken as the candidate video frame sequence.

In the embodiments, a segmentation operation may be performed on the acquired video frame sequence to obtain a plurality of sub-video frame sequences. Each of the obtained sub-video frame sequences may be taken as the candidate video frame sequence. In this case, the frame selection operation may be respectively performed on all the obtained sub-video frame sequences, the final global frame selection result may be determined based on the frame selection operation result of each sub-video frame sequence, and the final global frame selection result may be applied to any corresponding scenario such as feature extraction, attribute extraction, or information fusion, as an example. One or more of the sub-video frame sequences may be selected from the plurality of sub-video frame sequences as the candidate video frame sequence(s), frame selection operations may be respectively performed on the selected sub-video frame sequences, and the final global frame selection result may be determined based on the result of each frame selection operation. The quantity of sub-video frame sequences obtained by segmenting the video frame sequence is not limited, and therefore a quantity of video frames included in each sub-video frame sequence is also not limited.

In an example, a quantity of video frames included in each sub-video frame sequence may be related to a frame rate R of a video frame sequence. For example, a quantity of video frames included in each sub-video frame sequence may be 0.5R, R, 1.5R or 2R and the like. Meanwhile, the mode of selecting a sub-video frame sequence as a candidate frame sequence is not limited. Flexible selection can be carried out based on actual conditions.

In one or more examples, the video frame sequence may be sequentially segmented at least one time in a time domain, in which case at least two sub-video frame sequences may be obtained. The sub-video frame sequences are mutually consecutive in the time domain, i.e. two video frames at neighbor regions of two segmented adjacent sub-video frame sequences are consecutive with no gap therebetween. For example, twice segmentation may be made in sequence at time domain positions A1 and A2 of the video frame sequence, where A2 is after A1 in the time domain. In this case, three sub-video frame sequences are available, denoted as SA1, SA2 and SA3, respectively. SA1 is a first sub-sequence of the video frame sequence, the start and end points of which are a start position and the time domain position A1 of the video frame sequence, respectively. SA2 is a second sub-sequence of the video frame sequence, the start and end points of which are the time domain positions A1 and A2, respectively. SA3 is a third sub-sequence of the video frame sequence, the start and end points of which are the time domain position A2 and an end position of the video frame sequence. SA1, SA2 and SA3 are adjacent and consecutive in the time domain in sequence and do not include a same video frame with each other. The video frame sequence may also be segmented into a plurality of sub-video frame sequences in other manners, which are not specifically limited.

In one or more examples, the video frame sequence may be segmented at least once in sequence. The segmentation may not be made in a time-domain order. In this case, at least two sub-video frame sequences may be obtained. A union of the sub-video frame sequences is a video frame sequence. There may be an intersection between different sub-video frame sequences, i.e. there may be a certain video frame. There are simultaneously two different sub-video frame sequences. For example, one segmentation may be made at a time domain position B1 of the video frame sequence, at which time two sub-video frame sequences, denoted as SB1 and SB2, may be obtained. SB1 is a first sub-sequence of the video frame sequence, the start and end points of which are a start position and the time domain position B1 of the video frame sequence, respectively. SA2 is a second sub-sequence of the video frame sequence, the start and end points of which are the time domain position B1 and an end position of the video frame sequence, respectively. Then, the complete video frame sequence may be segmented once again. In this case, the segmentation may be made at a time domain position B2 of the video frame sequence. B2 is prior to B1 in the time domain. In this case, two new sub-video frame sequences may be obtained, denoted as SB3 and SB4, respectively. SB3 is a third sub-sequence of the video frame sequence, the start and end points of which are a start position and the time domain position B1 of the video frame sequence, respectively. SA4 is a fourth sub-sequence of the video frame sequence, the start and end points of which are the time domain position B2 and an end position of the video frame sequence, respectively. Four sub-video frame sequences SB1, SB2, SB3, and SB4 may be obtained finally. SB1 and SB2 are adjacent in the time domain and do not overlap, and SB3 and SB4 are adjacent and do not overlap in the time domain. However, a same video frame may exist between SB1 and SB3, and between SB2 and SB4.

In one or more examples, the video frame sequence may be segmented to obtain a plurality of sub-video frame sequences. The segmentation may be uniform segmentation, i.e. all the obtained sub-video frame sequences may include the same quantity of video frames. Or, the segmentation may be nonuniform segmentation, i.e. there may be two sub-video frame sequences which include different quantities of video frames in the segmented result.

Based on the embodiments, in one or more examples, the operation that the video frame sequence is segmented to obtain a plurality of sub-video frame sequences may include that: the video frame sequence is segmented in a time domain to obtain at least two sub-video frame sequences, each sub-video frame sequence including a same quantity of video frames.

FIG. 2 is a schematic diagram of segmenting a video frame sequence according to an embodiment of the present disclosure. As shown in FIG. 2, In an example, the video frame sequence may be directly segmented in a time-domain order into three sub-video frame sequences, denoted as slice 1, slice 2, and slice 3, respectively. Slice 1, slice 2, and slice 3 include the same quantity of video frames.

According to the above embodiment, the quantity of sub-video frame sequences obtained by segmenting the video frame sequence is not limited, which can be flexibly selected based on actual conditions. Therefore, in one or more examples, the operation that the video frame sequence is segmented to obtain a plurality of sub-video frame sequences may further include that: a quantity of video frames included in each sub-video frame sequence is determined based on a predetermined requirement; and the video frame sequence is segmented in a time domain based on the quantity to obtain at least two sub-video frame sequences.

The above predetermined requirements may be flexibly determined based on practical situations. In one or more examples, the predetermined requirements may be real-time requirements. In an example, a quantity of video frames included in each sub-video frame sequence may be determined based on the real-time requirements. The specific type of the real-time requirements is not limited. In one or more examples, the real-time requirements may be real-time application requirements of a frame selection result. In an example, the final frame selection result may be used for pushing an image or picture, which is called pushing a picture, for short, i.e., sending a selected image or picture to a specified position. The specific destination and target object to be sent are not limited herein. When the final frame selection result is used for pushing a picture, there may be a requirement on real-time picture pushing. When a high real-time requirement requires real-time picture pushing, i.e. within a specified time range, the frame selection result needs to be sent to a corresponding position in time, and the specified time range can be flexibly set based on actual conditions. For example, the real-time picture pushing may be: sending the frame selection result to a user immediately after the user takes a video. Therefore, under the high real-time requirement, a quantity of video frames included in each segmented sub-video frame sequence may be set to be small. In this case, at least one sub-video frame sequence may be selected as a candidate video frame sequence to subject to a frame selection operation. Since a quantity of video frames included in the candidate video frame sequence is small, the execution speed of the frame selection operation can be fast, and the high real-time requirement of picture pushing can be met. Large latency of frame selection in the related art can also be minimized. Under a low real-time requirement such as a requirement that non-real-time picture pushing can be carried out, namely a specified time range is not set, the frame selection result may be sent to a corresponding position after the frame selection is finished. For example, the non-real-time picture pushing may be that after a video is captured by a user, the captured video is subjected to frame selection to obtain a final frame selection result and then sent to the user. Therefore, under the low real-time requirement, a quantity of video frames included in each segmented sub-video frame sequence may be set to be large. In this case, a plurality of sub-video frame sequences or even all sub-video frame sequences may be selected as candidate frame sequences for frame selection. Since a quantity of video frames included in a candidate frame sequence is large, the speed of implementing frame selection is low. However, the quality of the obtained global frame selection result is higher, and thus the quality of the pushed picture can be improved.

As can be seen from the above embodiments, at least one candidate video frame sequence may be acquired, and a subsequent frame selection operation may be carried out based on the obtained candidate video frame sequence, so that a final frame selection result is obtained. In this way, the flexibility of the whole video processing can be improved. As a final frame selection result may have a requirement of real-time application, a length of a candidate video frame sequence can be shortened based on the flexible acquisition mode of the candidate video frame sequence when the high real-time requirement is met, and the quantity of candidate video frame sequences subjected to intra-sequence frame selection can also be reduced, so that the amount of frame selection data involved in the intra-sequence frame selection can be reduced, and the frame selection speed can be improved. In this way, the requirement of high real-time application of a frame selection result can be met, and large latency in the frame selection process can be reduced. Also, a length of a candidate video frame sequence can be increased when the requirement on real timeness is low, and the quantity of candidate video frame sequences subjected to intra-sequence frame selection may be increased, so that the quality of the frame selection result can be improved while the basic real-time requirement is guaranteed.

In operation S12, intra-sequence frame selection is performed on each candidate video frame sequence to obtain a first frame selection result respectively corresponding to each candidate video frame sequence.

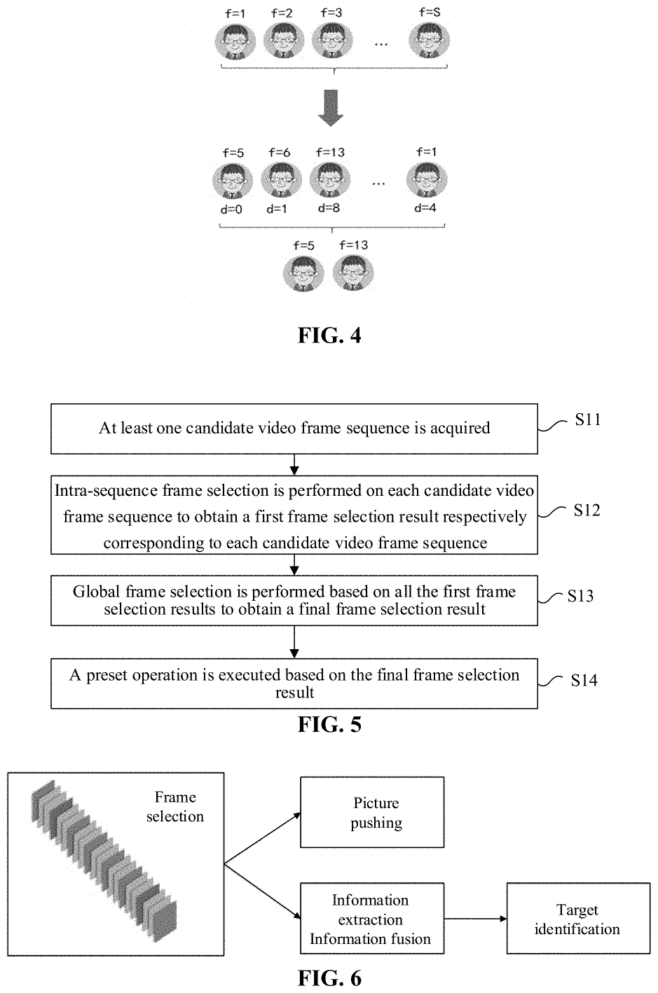

In one or more examples, FIG. 3 is a schematic flowchart 2 of a video processing method according to an embodiment of the present disclosure. S12 may include the following operations.

In operation S121, a quality parameter of each video frame in the at least one candidate video frame sequence is acquired.

In one or more examples, the quality parameter of each video frame may be at least one of following indexes: a definition of each video frame, a state of a target object in each video frame, other comprehensive parameters that can evaluate quality, and the like. There is no restriction on which index is used for determining the quality parameter of each video frame, and flexible selection may be made based on actual conditions. Since the standard of evaluating the quality of a video frame is not specifically limited, the quality parameter of the video frame can be obtained in different ways based on different quality evaluation standards.

In an example, the quality parameter of each video frame in the at least one candidate video frame sequence may be acquired by reading a definition of a picture. In an example, the quality parameter of each video frame in the at least one candidate video frame sequence may be acquired by reading an angle of a target object in a picture. Since the target object may have a plurality of different judgment angles, a deflection angle of the target object may be read to acquire a quality parameter of a video frame, or a yaw angle of the target object may be read to acquire the quality parameter of the video frame. The quality parameter of each video frame in the at least one candidate video frame sequence may also be acquired by reading a size of the target object. In an example, multiple indexes may be integrated to determine a quality parameter of a video frame. A judgment model of a quality parameter of a video frame may be established. Exemplarily, the judgment model may be a neural network model, so that after each video frame sequentially passes through the established judgment model, the quality of each video frame in the at least one candidate video frame sequence may be acquired by comparing output results of the judgment model.

In operation S122, sorting is performed in the at least one candidate video frame sequence based on the quality parameter.

Since the quality parameter of each video frame is acquired, each video frame may be sorted based on the quality parameter of each video frame, subsequent operations are facilitated, and a specific sorting mode may be flexibly determined based on actual conditions. In an example, the ordering may be in the order of the quality parameter of each video frame from high to low or from low to high.

In one or more examples, before operation S123 following the operation S122 is executed, the method may further include the following operations: a number is sequentially configured for each video frame in the at least one candidate frame sequence according to a time sequence of each video frame in the at least one candidate video frame sequence; and a frame interval between video frames in the sorted at least one candidate video frame sequence is obtained based on an absolute value of a number difference between the video frames.

In the embodiment, the frame interval between the video frames may refer to an interval relationship between the video frames in the time domain. No limitation is set for a specific index for indicating the frame interval between different video frames. In an example, the frame interval between video frames may refer to a difference between the video frames in the time domain. In an example, the frame interval between video frames may also refer to the quantity of video frames separated based on the time-domain order between video frames. Therefore, the operations involved in the above embodiments are intended to quantize the frame interval between video frames. In an example, the frame interval may be quantized based on the quantity of video frames that are spaced apart when the video frames are sorted in the time domain. Therefore, in order to determine the quantity of video frames as an interval between every two video frames when sorted in the time domain, the video frames may be numbered in a chronological order, and an absolute value of a difference between the numbers of any two video frames may represent a distance between the two video frames. That is, a frame interval between any two video frames may be indicated.

The above-mentioned operation of acquiring the frame interval between two video frames may occur before Sorting is performed in the at least one candidate video frame sequence based on the quality parameter or after Sorting is performed in the at least one candidate video frame sequence based on the quality parameter. It should be noted that when the process of acquiring the frame interval occurs after Sorting is performed in the at least one candidate video frame sequence based on the quality parameter, the sequence may be changed in the time domain after sorting is performed based on quality. Therefore, if the frame interval is acquired by calculating the numbers, numbering needs to be performed based on the candidate video frame sequences which are not subjected to quality-based sorting.

In operation S123, frame extraction is performed on the sorted at least one candidate video frame sequence based on a predetermined frame interval to obtain the first frame selection result respectively corresponding to each candidate video frame sequence.

The specific implementation of operation S123 may be determined based on actual conditions. In one or more examples, operation S123 may include that: a video frame with a highest quality parameter is selected from each of the sorted at least one candidate video frame sequence, and the video frame with the highest quality parameter is taken as the first frame selection result respectively corresponding to each candidate video frame sequence.

In the embodiment, only one video frame may need to be selected from each candidate video frame sequence. In this case, the video frame with the highest quality parameter in each candidate video frame sequence may be selected as a frame selection result to improve the quality of frame selection.

In one or more examples, operation S123 may include that: a video frame with a highest quality parameter is selected from each of the sorted at least one candidate video frame sequence as a first selected video frame; k1 video frames are sequentially selected from each of the sorted at least one candidate video frame sequence according to a sorting sequence, wherein a frame interval between a currently selected video frame and any other selected video frame is greater than a predetermined frame interval, where k1 is an integer greater than or equal to 1; and all the selected video frames are taken as the first frame selection result respectively corresponding to each candidate video frame sequence.

In the embodiment, a video frame with a highest quality parameters in a candidate frame sequence may be selected as a first selected video frame by sorting based on a quality parameter. Since a quantity of video frames required to be selected finally is k1+1, k1 video frames need to be selected from the remaining video frames other than the video frame with the highest quality parameter in the candidate frame sequence. When the selected video frames are adjacent or close, these video frames may have higher similarity, so that the information overlapping degree of the video frames is higher, and the application value of the video frames is reduced. Therefore, in the embodiments of the present disclosure, there should be a frame interval between each of the k1 video frames selected from the remaining video frames and the first selected video frame, and there should also be a certain frame interval between every two of the k1 video frames, so that the representativeness and the information complementarity of the frame selection result can be improved. Meanwhile, the quality of the frame selection result should also be guaranteed and should be avoided from being degraded in order to improve the representativeness of the frame selection result. For the above reasons, the method for selecting k1 video frames may be as follows: since the quality of each video frame in the sorted at least one candidate frame sequence is sequentially reduced, the first selected video frame is the first video frame in the sorted at least one candidate frame sequence. In this case, a frame interval between each video frame and the first selected video frame may be sequentially calculated from the sorted at least one candidate frame sequence starting from the second video frame. When a calculated frame interval is greater than a predetermined frame interval, it may be taken as a second selected frame interval. Then frame intervals between each video frame and the first selected video frame and the second selected video frame may be calculated in sequence starting from a first video frame after the second selected frame interval. When the calculated two frame intervals are greater than the predetermined frame interval, they may be taken as a third selected frame interval, and so on until k1 video frames are finally selected. Then k1 video frames and the first selected video frame are taken as a frame selection operation result of the candidate frame sequence, namely the first frame selection result. The predetermined frame interval in the above embodiments may be set based on the actual situations. In an example, the predetermined frame interval may be ¼ of the length of the candidate frame sequence, i.e., ¼ of video frames in the candidate frame sequence.

As can be seen from the above process, a frame interval between a video frame selected each time and each selected video frame is greater than a predetermined frame interval, so that the frame interval between any two video frames is greater than the predetermined frame interval in the final selected first frame selection result. Meanwhile, when the frame selection operation is performed, a next video frame may be selected in an order of video-frame quality parameters from high to low, so that the quality of the video frames can be guaranteed. In summary, the first frame selection result obtained by executing frame selection on the at least one candidate frame sequence has better quality and better representativeness and information complementarity.

FIG. 4 is a schematic diagram of a frame selection process according to an embodiment of the present disclosure. As shown in FIG. 4, in an example, a particular process of performing frame selection on a candidate video frame sequence may include: a quantity of video frames included in the candidate video frame sequence is S, so that the S video frames can be numbered first in a time-domain order in the candidate video frame sequence. After the numbering is completed, the S video frames can be sorted based on a quality parameter to obtain a sorting result in the figure. Based on the sorting result in the figure, frame selection may begin. First, it can be seen from the sorting result that the quality of a video frame numbered as 5 (f=5) is the best, so that the video frame numbered as 5 (f=5) is taken as the first selected video frame, and after the video frame is selected, a next video frame is selected based on a predetermined frame interval. In the embodiments of the present disclosure, the predetermined frame interval is set to 3. Therefore, as can be seen from the sorting result, although the quality of a video frame numbered as 6 is high, it cannot be selected because its distance from the video frame numbered as 5 is 1, which is less than the predetermined frame interval 3. A picture numbered as 13 meets the condition and thus becomes a picture with the second quality rank. In this example, the quantity of video frames finally required to be selected is two, i.e., the two finally selected video frames are video frames numbered as 5 and 13, respectively.

In one or more examples, the process of operation S12 may also include that: a video frame with a highest quality parameter is selected from a candidate frame sequence as a first selected video frame, video frames in the candidate frame sequence are not sorted based on quality parameters, video frames with frame intervals between themselves and the first selected video frame being smaller than a predetermined frame interval are excluded based on the requirement on the predetermined frame interval, and a video frame with a highest quality is selected from the remaining selectable video frames as a second selected video frame. Since the video frames with the frame intervals to the first selected video frame being smaller than the predetermined frame interval do not exist in the remaining optional frames after the first exclusion, the video frames with the frame interval to the second selected video frame being smaller than the predetermined frame interval are directly excluded from the remaining selectable frames, and a video frame with a highest quality is selected from the remaining selectable frames as a third selected video frame, and so on until all video frames are selected. As frame interval judgment and quality screening are also performed in this process, video frames with better quality and better representativeness and information complementarity can be selected.

In operation S13, global frame selection is performed based on all the first frame selection results to obtain a final frame selection result.

In the embodiment, there may be various implementations of performing global frame selection based on all the first frame selection results to obtain a final frame selection result. In one or more examples, the operation S13 may include that: the first frame selection result is taken as the final frame selection result; or, k2 video frames with the highest quality are selected from all the first frame selection results, and the k2 video frames are taken as a final frame selection result, where k2 is an integer greater than or equal to 1.

In the first implementation, there may be multiple cases where the first selected frame result is taken as the final selected frame result. In an example, only one candidate video frame sequence is subjected to frame selection to obtain a first frame selection result. Therefore, the first frame selection result may be directly taken as the final frame selection result. In an example, multiple candidate video frame sequences may be subjected to frame selection so as to obtain multiple first frame selection results. When the sum of quantities of all the first frame selection results does not exceed the quantity requirement of the final frame selection result, all the obtained first frame selection results may be directly used together as the final frame selection result. When the sum of quantity of all the first frame selection results does not exceed the quantity requirement of the final frame selection result, all the obtained first frame selection results may be taken as a set, and a frame interval between any two video frames in the set may be calculated; and if a frame interval between two video frames is smaller than a predetermined frame interval, a video frame with lower quality in the two frames is excluded until there are no two video frames having a frame interval less than the predetermined frame interval. In this case, the obtained set may be taken as a final global frame selection result.

In the second implementation, k2 video frames with the highest quality may be selected from the first frame selection result, and a value of k2 may be set based on actual situations and is not specifically limited herein. There may also be multiple situations where the k2 video frames are taken as the final frame selection result. In an example, only one candidate video frame sequence is subjected to frame selection, and a quantity of video frames included in the obtained first frame selection result is greater than k2. Since the first frame selection result is calculated based on the frame interval, the frame interval between any two video frames in the first frame selection result is greater than a predetermined frame interval. Therefore, the k2 video frames with the highest quality in the first frame selection result may be taken as the final frame selection result to guarantee the quality of frame selection. In an example, multiple candidate video frame sequences may be subjected to frame selection, and the sum of quantity of all the first frame selection results exceeds k2, in which case all the obtained first frame selection results may be directly taken together as a set from which the k2 video frames with the highest quality are selected to guarantee the quality of frame selection. In an example, multiple candidate video frame sequences may be subjected to frame selection, and the sum of quantity of all the first frame selection results exceeds the quantity requirement of the final frame selection result. In this case, all the obtained first frame selection results may be taken as one candidate video frame sequence again. Selecting k2 video frames from the candidate video frame sequence as the final frame selection result through the intra-sequence frame selection method in any of the above embodiments can minimize the existence of adjacent video frames between video frames selected in different first frame selection results. For example, in the candidate video frame sequence as shown in FIG. 2, the last video frame of slice 1, denoted as video frame A, may be the first frame selection result of slice 1, and the first video frame of slice 2, denoted as video frame B, may be the first frame selection result of slice 2, both of which may act as an alternative in the final frame selection result. If the final frame selection results are sorted directly by quality, the final frame selection results may include both video frame A and video frame B. As can be seen from the figure, video frame A is adjacent to video frame B, so that the final frame selection results obtained in this case may be have lower representativeness. Therefore, all the first frame selection results obtained in this case can be used again as a candidate frame sequence. Through the intra-sequence frame selection operation of any of the above embodiments, the obtained final frame selection result can be more representative.

According to the embodiments of the present disclosure, based on quality parameter of video frames and frame intervals among the video frames, adjacent frames can be effectively avoided while the quality of a frame selection result is guaranteed, so that the representativeness and the information complementarity of the frame selection result are improved, and the subsequent application of the frame selection result is facilitated.

Based on the foregoing embodiments, FIG. 5 is a schematic flowchart 3 of a video processing method according to an embodiment of the present disclosure. As shown in FIG. 5, in one or more examples, the method may further include the following operations.

In operation S14, a preset operation is executed based on the final frame selection result.

In one or more examples, any preset operation may be executed based on the final frame selection result, the preset operation is not limited, and any operation executed based on the applicable frame selection result may be taken as the preset operation.

In one or more examples, operation S14 may include that: the final frame selection result is sent; or, a target identification operation is executed based on the final frame selection result.

In the implementation, there may be many cases for the manner, object, and type of transmission of the final frame selection result, which are not limited thereto. In one or more examples, transmission of the final frame selection result may include: sending the final frame selection result in real time; and/or sending the final frame selection result not in real time. In an example, the operation of sending the final frame selection result in real time may be executed only, and the specific process may be that frame selection on the acquired video frame sequence is started while acquiring the video frame sequence, and the final frame selection result is sent in time. In an example, the operation of sending the final frame selection result not in real time may be executed only, and the specific process may be that a video frame sequence is acquired, frame selection is performed after acquiring the complete video frame sequence, and the final frame selection result is sent. In an example, the operation of sending the final frame selection result in real time and sending the final frame selection result not in real time may be executed at the same time, and the specific process may be that in the process of acquiring the video frame sequence, frame selection is performed on a part of the acquired video frame sequence, the frame selection result is sent in time; and after the whole process of acquiring the video frame sequence is finished, sequential intra-sequence frame selection and global frame selection are performed on the basis of the complete video frame sequence, and the final frame selection result is sent.

In one or more examples, the operation that the target identification operation is executed based on the final frame selection result may include that: image features of each video frame in the final frame selection result are extracted; a feature fusion operation is executed on the image features to obtain a fused feature; and the target identification operation is executed based on the fused feature.

In the above embodiment, the manner of extracting the image features of each video frame in the final frame selection result is not limited and can be flexibly selected based on actual situations. In an example, the image features of each video frame may be extracted by a neural network, and the specific neural network and the training mode of the neural network are not limited here, and can be flexibly selected based on actual situations. Since the manner in which the image features of each video frame are extracted is not limited, the obtained image features may also exist in different forms, and thus the implementation mode in which the feature fusion operation is executed on each image feature can be flexibly selected based on the actual situations of each image feature, and is not limited thereto. After the fused feature is obtained, the implementation for executing the target identification operation based on the fused feature is also not limited here, and can be flexibly selected based on the actual situations of the fused feature. In an example, face recognition operations may be performed based on the fused feature. In an example, the fused feature may also be convoluted by a convolution neural network.

The video processing methods of the embodiments of the present disclosure are illustrated below in conjunction with specific application scenarios.

In intelligent video analysis tasks, objects typically last from seconds to tens of seconds from appearance to disappearance in a picture. At a frame rate of 25 frames/second, typically hundreds of snapshot pictures may be produced. In the case of limited computing resources, it is not necessary to take all the resources to perform information extraction, such as feature extraction or attribute extraction. In order to make better use of information of captured pictures, several high-quality captured pictures may be selected from a whole tracking process of a target for information extraction and fusion.

How to select a plurality of representative high-quality snapshot pictures which are favorable for improving the identification rate from a plurality of snapshot pictures is a frame selection strategy in the embodiments of the present disclosure. A good frame selection strategy should not only be able to select high-definition and high-quality snapshots, but also be able to find out complementary information snapshots. However, general frame selection strategies are often based only on quality scores. The similarity of the same target between adjacent frame pictures in the captured pictures is often very high, and the redundancy is very large, so the frame selection strategy only considering the picture quality is not favorable for selecting representative and information complementary captured pictures.

By adopting the video processing method of the embodiments of the present disclosure to process an acquired video frame sequence, selected optimal frames can be effectively prevented from being adjacent, so that the complementarity of information between the selected optimal frames is improved.

FIG. 6 is a schematic diagram of an application example according to an embodiment of the present disclosure. As shown in FIG. 6, selected video frames may be pushed to a user for displaying or other operations (i.e. picture pushing shown in the figure) on the one hand, and selected optimal pictures may continue being subjected to information extraction, information fusion and target identification on the other hand. When the selected video frames are applied to video processing, not only the calculation cost can be reduced, but also feature fusion can be carried out so as to improve the identification accuracy.

It should be noted that the video processing method of the embodiments of the present disclosure is not limited to be applied to the example scenarios described above, but may be applied to any video processing or image processing process, and is not limited by the present disclosure.

It is to be understood that the method embodiments mentioned in the present disclosure may be combined with each other to form a combined embodiment without departing from the principle and logic, which is not elaborated in the embodiments of the present disclosure for the sake of simplicity.

It may be understood by the person skilled in the art that in the method of the specific implementations, the sequence of each operation does not mean a strict execution sequence to form any limit to the implementation process, and the specific execution sequence of each operation may be determined in terms of the function and possible internal logic.

FIG. 7 is a block diagram of a video processing apparatus according to an embodiment of the present disclosure. As shown in FIG. 7, an apparatus 20 for video processing includes:

an acquisition module 21, configured to acquire at least one candidate video frame sequence;

an intra-sequence frame selection module 22, configured to perform intra-sequence frame selection on each candidate video frame sequence to obtain a first frame selection result respectively corresponding to each candidate video frame sequence; and

a global frame selection module 23, configured to perform global frame selection based on all the first frame selection results to obtain a final frame selection result.

In one or more examples, the apparatus may further include a preprocessing module, configured to, before the acquisition module acquires the at least one candidate video frame sequence, acquire a video frame sequence, segment the video frame sequence to obtain a plurality of sub-video frame sequences, and take the sub-video frame sequence as the candidate video frame sequence.

In one or more examples, the preprocessing module is configured to segment the video frame sequence in a time domain to obtain at least two sub-video frame sequences, each sub-video frame sequence including a same quantity of video frames.

In one or more examples, the preprocessing module is configured to determine a quantity of video frames included in each sub-video frame sequence based on a predetermined requirement, and segment the video frame sequence in a time domain based on the quantity to obtain at least two sub-video frame sequences.

In one or more examples, the intra-sequence frame selection module may include: a quality parameter acquisition sub-module, configured to acquire a quality parameter of each video frame in the at least one candidate video frame sequence; a sorting sub-module, configured to perform sorting in the at least one candidate video frame sequence based on the quality parameter; and a frame extraction sub-module, configured to perform frame extraction on the sorted at least one candidate video frame sequence based on a predetermined frame interval to obtain the first frame selection result respectively corresponding to each candidate video frame sequence.

In one or more examples, the intra-sequence frame selection module may further include: a frame interval acquisition sub-module, configured to: before the frame extraction sub-module performs frame extraction on the sorted at least one candidate video frame sequence based on the predetermined frame interval, sequentially configure a number for each video frame in the at least one candidate frame sequence according to a time sequence of each video frame in the at least one candidate video frame sequence; and obtain a frame interval between video frames in the sorted at least one candidate video frame sequence based on an absolute value of a number difference between the video frames.

In one or more examples, the frame extraction sub-module is configured to select a video frame with a highest quality parameter from each of the sorted at least one candidate video frame sequence, and take the video frame with the highest quality parameter as the first frame selection result respectively corresponding to each candidate video frame sequence.

In one or more examples, the frame extraction sub-module is configured to select a video frame with a highest quality parameter from each of the sorted at least one candidate video frame sequence as a first selected video frame; sequentially select k1 video frames from each of the sorted at least one candidate video frame sequence according to a sorting sequence, wherein a frame interval between a currently selected video frame and any other selected video frame is greater than a predetermined frame interval, where k1 is an integer greater than or equal to 1; and take all the selected video frames as the first frame selection result respectively corresponding to each candidate video frame sequence.

In one or more examples, the global frame selection module is configured to: take the first frame selection result as the final frame selection result; or, select k2 video frames with a highest quality from all the first frame selection results, and take the k2 video frames as the final frame selection result, where k2 is an integer greater than or equal to 1.

In one or more examples, the apparatus may further include a frame selection result operation module, configured to execute a preset operation based on the final frame selection result.

In one or more examples, the frame selection result operation module is configured to: send the final frame selection result; or, execute a target identification operation based on the final frame selection result.

In one or more examples, the frame selection result operation module is configured to: extract image features of each video frame in the final frame selection result; execute a feature fusion operation on the image features to obtain a fused feature; and execute the target identification operation based on the fused feature.

In some embodiments, the functions or modules included in the apparatus provided in the embodiment of the present disclosure may be configured to perform the method described in the above method embodiments. The specific implementation may refer to the description of the above method embodiments. For brevity, descriptions are omitted herein.

The embodiments of the present disclosure further provide a computer-readable storage medium, which stores a computer program thereon. The computer program is executed by a processor to implement any one of the above method embodiments. The computer-readable storage medium may be a non-volatile computer-readable storage medium.

The embodiments of the present disclosure further provide an electronic device, which includes: a processor; and a memory configured to store instructions executable by the processor, the processor calling the executable instructions to implement any one method embodiment of the present disclosure. Specific procedures and arrangements may be made with reference to the specific description of the corresponding method embodiments of the present disclosure, and will not described in detail herein for the sake of simplicity.

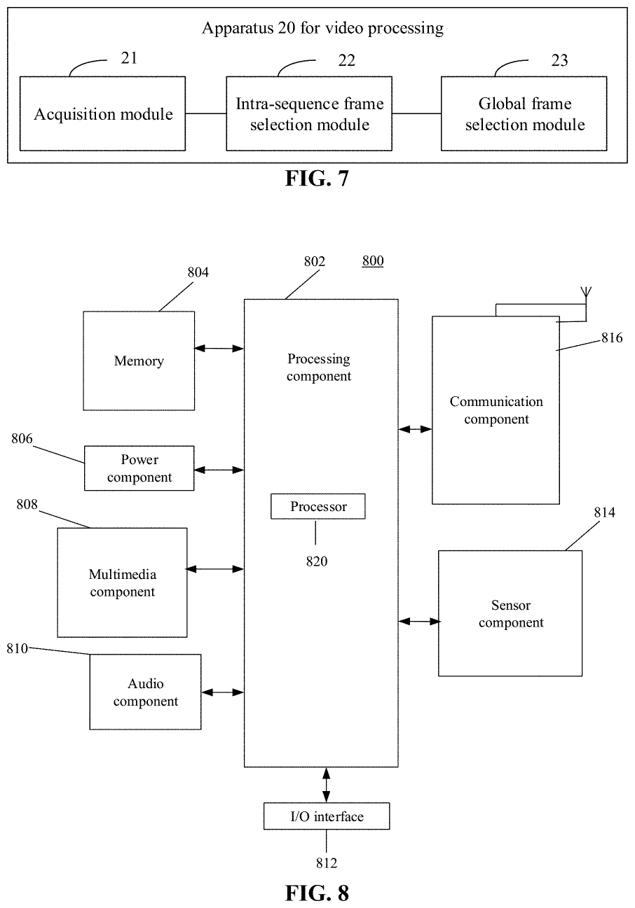

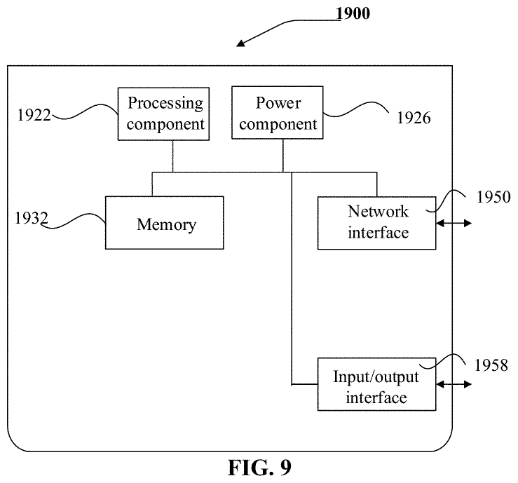

FIG. 8 is a block diagram of an electronic device according to an embodiment of the present disclosure. For example, the electronic device 800 may be one of terminals such as a mobile phone, a computer, a digital broadcast terminal, a messaging device, a gaming console, a tablet, a medical device, exercise equipment, and a PDA.

Referring to FIG. 8, the electronic device 800 may include one or more of the following components: a processing component 802, a memory 804, a power component 806, a multimedia component 808, an audio component 810, an Input/Output (I/O) of interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the above described methods. Moreover, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operation of the electronic device 800. Examples of such data include instructions for any applications or methods operated on the electronic device 800, contact data, phonebook data, messages, pictures, video, etc. The memory 804 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read Only Memory (ROM), a magnetic memory, a flash memory, a magnetic or optical disk.

The power component 806 provides power to various components of the electronic device 800. The power component 806 may include a power management system, one or more power sources, and any other components associated with the generation, management and distribution of power in the electronic device 800.

The multimedia component 808 includes a screen providing an output interface between the electronic device 800 and the user. In some embodiments, the screen may include a Liquid Crystal Display (LCD) and a Touch Panel (TP). If the screen includes the TP, the screen may be implemented as a touch screen to receive input signals from the user. The TP includes one or more touch sensors to sense touches, swipes and gestures on the TP. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, or buttons. The buttons may include, but are not limited to, a home button, a volume button, a starting button, and a locking button.

The sensor component 814 includes one or more sensors to provide status assessments of various aspects of the electronic device 800. For example, the sensor component 814 may detect an open/closed status of the electronic device 800, and relative positioning of components. For example, the component is the display and the keypad of the electronic device 800. The sensor component 814 may also detect a change in position of the electronic device 800 or a component of the electronic device 800, a presence or absence of user contact with the electronic device 800, an orientation or an acceleration/deceleration of the electronic device 800, and a change in temperature of the electronic device 800. The sensor component 814 may include a proximity sensor configured to detect the presence of nearby objects without any physical contact. The sensor component 814 may also include a light sensor, such as a Complementary Metal-Oxide Semiconductor (CMOS) or Charge Coupled Device (CCD) image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate communication, wired or wirelessly, between the electronic device 800 and other devices. The electronic device 800 may access a wireless network based on a communication standard, such as WiFi, 2G or 3G, or a combination thereof. In one exemplary embodiment, the communication component 816 receives a broadcast signal or broadcast associated information from an external broadcast management system via a broadcast channel. In one exemplary embodiment, the communication component 816 further includes a Near Field Communication (NFC) module to facilitate short-range communications. For example, the NFC module may be implemented based on a Radio Frequency Identification (RFID) technology, an Infrared Data Association (IrDA) technology, an Ultra Wideband (UWB) technology, a Bluetooth (BT) technology, and other technologies.

In exemplary embodiments, the electronic device 800 may be implemented with one or more Application Specific Integrated Circuits (ASICs), Digital Signal Processors (DSPs), Digital Signal Processing Devices (DSPD), Programmable Logic Devices (PLDs), Field-Programmable Gate Arrays (FPGAs), controllers, micro-controllers, microprocessors, or other electronic elements, for performing the above described methods.

In an exemplary embodiment, a non-volatile computer-readable storage medium, for example, a memory 804 including a computer program, is also provided. The computer program may be executed by a processor 820 of an electronic device 800 to implement the above-mentioned method.

FIG. 9 is another block diagram of an electronic device according to an embodiment of the present disclosure. For example, an electronic device 1900 may be provided as a server. Referring to FIG. 9, the electronic device 1900 includes a processing component 1922, which further includes one or more processors. The electronic device 1900 includes a memory resource represented by a memory 1932, configured to store instructions executable by the processing component 1922, for example, an application program. The application program stored in the memory 1932 may include one or more modules, with each module corresponding to one group of instructions. In addition, the processing component 1922 is configured to execute the instruction to execute the above-mentioned method.

The electronic device 1900 may also include a power component 1926 configured to execute power management of the electronic device 1900, a wired or wireless network interface 1950 configured to connect the electronic device 1900 to a network, and an I/O interface 1958. The electronic device 1900 may be operated based on an operating system stored in the memory 1932, for example, Windows Server™, Mac OS X™, Unix™, Linux™, FreeBSD™ or the like.

In an exemplary embodiment, the embodiment of the present disclosure also provides a non-volatile computer-readable storage medium, for example, a memory 1932 including a computer program instruction. The computer program instruction may be executed by the processing component 1922 of the electronic device 1900 to execute the above-mentioned method.

The present disclosure may be a system, a method and/or a computer program product. The computer program product may include a computer-readable storage medium, in which a computer-readable program instruction configured to enable a processor to implement each aspect of the present disclosure is stored.

The computer-readable storage medium may be a physical device capable of retaining and storing an instruction used by an instruction execution device. The computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as an Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the present disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely or partially executed in a computer of a user, executed as an independent software package, executed partially in the computer of the user and partially in a remote computer, or executed completely in the remote server or a server. In a case involved in the remote computer, the remote computer may be connected to the user computer via an type of network including the LAN or the WAN, or may be connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instruction. The electronic circuit may execute the computer-readable program instruction to implement each aspect of the present disclosure.

Herein, each aspect of the present disclosure is described with reference to flowcharts and/or block diagrams of the method, device (system) and computer program product according to the embodiments of the present disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating operations are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

In the embodiments of the present disclosure, a final frame selection result may be obtained by sequentially performing intra-sequence frame selection and global frame selection on candidate video frame sequences. According to the embodiments of the present disclosure, the intra-sequence frame selection and the global frame selection may be performed on the candidate video frame sequences in sequence, so that the possibility that adjacent video frames with high similarity occur in the frame selection result can be reduced, and the representativeness and the information complementarity of a video processing result are improved.

The flowcharts and block diagrams in the drawings illustrate probably implemented system architectures, functions and operations of the system, method and computer program product according to multiple embodiments of the present disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the present disclosure has been described above. The above descriptions are exemplary, non-exhaustive and also not limited to each embodiment. Many modifications and variations are apparent to those of ordinary skill in the art without departing from the scope and spirit of each described embodiment of the present disclosure. The terms used herein are selected to explain the principle and practical application of each embodiment or technical improvements in the technologies in the market best or enable others of ordinary skill in the art to understand each embodiment disclosed herein.

1. A method for video processing, comprising:
acquiring at least one candidate video frame sequence;
performing intra-sequence frame selection on each candidate video frame sequence to obtain a first frame selection result respectively corresponding to each candidate video frame sequence; and
performing global frame selection based on all the first frame selection results to obtain a final frame selection result.

2. The method according to claim 1, wherein before acquiring the at least one candidate video frame sequence, the method further comprises:
acquiring a video frame sequence;
segmenting the video frame sequence to obtain a plurality of sub-video frame sequences, and
taking the sub-video frame sequence as the candidate video frame sequence.

3. The method according to claim 2, wherein segmenting the video frame sequence to obtain the plurality of sub-video frame sequences comprises:
segmenting the video frame sequence in a time domain to obtain at least two sub-video frame sequences, each sub-video frame sequence including a same quantity of video frames.

4. The method according to claim 2, wherein segmenting the video frame sequence to obtain the plurality of sub-video frame sequences further comprises:
determining a quantity of video frames included in each sub-video frame sequence based on a predetermined requirement; and
segmenting the video frame sequence in a time domain based on the quantity to obtain at least two sub-video frame sequences.

5. The method according to claim 1, wherein performing intra-sequence frame selection on each candidate video frame sequence to obtain the first frame selection result respectively corresponding to each candidate video frame sequence comprises:
acquiring a quality parameter of each video frame in the at least one candidate video frame sequence;
performing sorting in the at least one candidate video frame sequence based on the quality parameter; and
performing frame extraction on the sorted at least one candidate video frame sequence based on a predetermined frame interval to obtain the first frame selection result respectively corresponding to each candidate video frame sequence.

6. The method according to claim 5, wherein before performing frame extraction on the sorted at least one candidate video frame sequence based on the predetermined frame interval, the method further comprises:
sequentially configuring a number for each video frame in the at least one candidate frame sequence according to a time sequence of each video frame in the at least one candidate video frame sequence; and
obtaining a frame interval between video frames in the sorted at least one candidate video frame sequence based on an absolute value of a number difference between the video frames.

7. The method according to claim 5, wherein performing frame extraction on the sorted at least one candidate video frame sequence based on a predetermined frame interval to obtain the first frame selection result respectively corresponding to each candidate video frame sequence comprises:
selecting a video frame with a highest quality parameter from each of the sorted at least one candidate video frame sequence, and taking the video frame with the highest quality parameter as the first frame selection result respectively corresponding to each candidate video frame sequence.

8. The method according to claim 5, wherein performing frame extraction on the sorted at least one candidate video frame sequence based on a predetermined frame interval to obtain the first frame selection result respectively corresponding to each candidate video frame sequence comprises:
selecting a video frame with a highest quality parameter from each of the sorted at least one candidate video frame sequence as a first selected video frame;
sequentially selecting k1 video frames in each of the sorted at least one candidate video frame sequence according to a sorting sequence, wherein a frame interval between a currently selected video frame and any other selected video frame is greater than a predetermined frame interval, where k1 is an integer greater than or equal to 1; and
taking all the selected video frames as the first frame selection result respectively corresponding to each candidate video frame sequence.

9. The method according to claim 1, wherein performing global frame selection based on all the first frame selection results to obtain the final frame selection result comprises:
taking the first frame selection result as the final frame selection result; or,
selecting k2 video frames with a highest quality from all the first frame selection results, and taking the k2 video frames as the final frame selection result, where k2 is an integer greater than or equal to 1.

10. The method according to claim 1, further comprising: executing a preset operation based on the final frame selection result.

11. The method according to claim 10, wherein executing the preset operation based on the final frame selection result comprises:
sending the final frame selection result; or,
executing a target identification operation based on the final frame selection result.

12. The method according to claim 11, wherein executing the target identification operation based on the final frame selection result comprises:
extracting image features of each video frame in the final frame selection result;
executing a feature fusion operation on the image features to obtain a fused feature; and
executing the target identification operation based on the fused feature.

13. An apparatus for video processing, comprising:
a processor; and
a memory configured to store instructions executable by the processor,
wherein the processor calls the executable instructions to implement operations comprising:
acquiring at least one candidate video frame sequence;
performing intra-sequence frame selection on each candidate video frame sequence to obtain a first frame selection result respectively corresponding to each candidate video frame sequence; and
performing global frame selection based on all the first frame selection results to obtain a final frame selection result.

14. The apparatus according to claim 13, wherein the processor is further configured to:
before acquiring the at least one candidate video frame sequence, acquire a video frame sequence, segment the video frame sequence to obtain a plurality of sub-video frame sequences, and take the sub-video frame sequence as the candidate video frame sequence.

15. The apparatus according to claim 14, wherein the processor is further configured to:
segment the video frame sequence in a time domain to obtain at least two sub-video frame sequences, each sub-video frame sequence including a same quantity of video frames; or
determine a quantity of video frames included in each sub-video frame sequence based on a predetermined requirement, and segment the video frame sequence in a time domain based on the quantity to obtain at least two sub-video frame sequences.

16. The apparatus according to claim 13, wherein the intra-sequence frame selection module comprises:
acquire a quality parameter of each video frame in the at least one candidate video frame sequence;
perform sorting in the at least one candidate video frame sequence based on the quality parameter; and
perform frame extraction on the sorted at least one candidate video frame sequence based on a predetermined frame interval to obtain the first frame selection result respectively corresponding to each candidate video frame sequence.

17. The apparatus according to claim 16, wherein
the processor is further configured to:
before performing frame extraction on the sorted at least one candidate video frame sequence based on the predetermined frame interval, sequentially configure a number for each video frame in the at least one candidate frame sequence according to a time sequence of each video frame in the at least one candidate video frame sequence; and
obtain a frame interval between video frames in the sorted at least one candidate video frame sequence based on an absolute value of a number difference between the video frames;
or,
the processor is further configured to select a video frame with a highest quality parameter from each of the sorted at least one candidate video frame sequence, and take the video frame with the highest quality parameter as the first frame selection result respectively corresponding to each candidate video frame sequence;
or,
the processor is further configured to:
select a video frame with a highest quality parameter from each of the sorted at least one candidate video frame sequence as a first selected video frame;
sequentially select k1 video frames in each of the sorted at least one candidate video frame sequence according to a sorting sequence, wherein a frame interval between a currently selected video frame and any other selected video frame is greater than a predetermined frame interval, where k1 is an integer greater than or equal to 1; and
take all the selected video frames as the first frame selection result respectively corresponding to each candidate video frame sequence.

18. The apparatus according to claim 13, wherein the processor is further configured to:
take the first frame selection result as the final frame selection result; or,
select k2 video frames with a highest quality from all the first frame selection results, and take the k2 video frames as the final frame selection result, where k2 is an integer greater than or equal to 1; or
execute a preset operation based on the final frame selection result.

19. The apparatus according to claim 18, wherein the processor is configured to:
send the final frame selection result; or, execute a target identification operation based on the final frame selection result; and
extract image features of each video frame in the final frame selection result; execute a feature fusion operation on the image features to obtain a fused feature; and execute the target identification operation based on the fused feature.

20. A non-volatile computer-readable storage medium, storing a computer program instruction thereon, wherein the computer program instruction is executed by a processor to implement operations comprising:
acquiring at least one candidate video frame sequence;
performing intra-sequence frame selection on each candidate video frame sequence to obtain a first frame selection result respectively corresponding to each candidate video frame sequence; and
performing global frame selection based on all the first frame selection results to obtain a final frame selection result.
